(19) United States
(12) Patent Application Publication
(10) Pub. No.: US 2026/0105741 A1
(43) Pub. Date: Apr. 16, 2026

(54) DYNAMIC IMAGE PROCESSING INFERENCE SELECTION USING QUALITY METRICS

(71) Applicant: NVIDIA Corporation, Santa Clara, CA (US)

(72) Inventors: Swapnil Jagdish Rathi, Pune (IN); Bhushan Rupde, Pune (IN)

(73) Assignee: NVIDIA Corporation, Santa Clara, CA (US)

(21) Appl. No.: 18/916,332

(22) Filed: Oct. 15, 2024

(51) Int. Cl. G06V 10/98; G06V 10/62; G06V 10/771

(52) U.S. Cl. CPC G06V 10/993; G06V 10/62; G06V 10/771

(57) ABSTRACT

Various examples, systems, and methods are disclosed relating to selecting and performing re-inference in a computer vision pipeline. A first computing system can determine at least one quality metric associated with performing at least one operation on an image frame. The at least one operation may correspond to an image processing pipeline associated with performing a first inference operation and a second inference operation on the image frame. The first computing system can select a portion of the image frame to perform the second inference operation responsive to the at least one quality metric satisfying a re-inference condition. The first computing system can perform, using at least one machine learning model, the second inference operation for the portion of the image frame.

### BACKGROUND

Artificial intelligence (AI) pipelines for image processing can have one or more inference stages, such as a primary inference and one or more secondary inferences or re-inferences. The inference stages may be operated at different rates, such as in relation to a frame rate of images to be processed. Some methods rely on fixed-interval sampling for secondary inference, which can lead to inefficiencies and increased computational demands. For example, this approach can result in redundant processing and failure to reprocess high-quality frames under varying data conditions. This can make it challenging to achieve accurate and efficient real-time or near real-time applications.

### SUMMARY

Implementations of the present disclosure relate to systems and methods for improving re-inference operations in computer vision pipelines using dynamic quality metrics. Systems and methods are disclosed that can utilize machine learning models, such as neural networks and transformers, combined with multi-dimensional quality metrics to analyze and determine which portions of image frames to further process. This can allow for more efficient use of computational resources by concentrating processing on frame regions where additional inferences provide measurable improvements in detection accuracy or object classification. For example, systems and methods in accordance with the present disclosure can adjust re-inference criteria in real-time (or near real-time) based on analyzing metrics such as confidence scores from primary and secondary detectors, bit allocation details from encoding processes, and object tracking stability, thereby refining the inference pipeline to enhance the performance and reliability of vision-based systems.

Some implementation relates to one or more processors including one or more circuits. The processing circuitry is to determine at least one quality metric associated with performing at least one operation on an image frame, the at least one operation corresponding to an image processing pipeline associated with performing a first inference operation and a second inference operation on the image frame. The processing circuitry is to select a portion of the image frame to perform the second inference operation responsive to the at least one quality metric satisfying a re-inference condition. The processing circuitry is to perform, using at least one machine learning model, the second inference operation for the portion of the image frame.

In some implementations, the re-inference condition is satisfied based at least on the at least one quality metric exceeding a previous quality metric or exceeding a predefined quality metric threshold. In some implementations, the at least one quality metric includes at least one of (i) a first confidence metric, (ii) a tracking confidence metric, (iii) a second confidence metric, or (iv) a decoder metric. In some implementations, performing the at least one operation includes performing, using the at least one machine learning model, the first inference operation on the image frame to determine the first confidence metric, the first confidence metric corresponding to a first accuracy of a detection of an object of the image frame.

In some implementations, performing the at least one operation includes generating, using an object tracker, tracking data regarding the object tracked by the object tracker between a first image frame and a second image frame to determine the tracking confidence metric, the tracking confidence metric corresponding to a consistency of the object of the image frame tracked over at least the first image frame and the second image frame. In some implementations, performing the at least one operation includes performing, using the at least one machine learning model, the second inference operation on the portion of the image frame to determine the second confidence metric, the second confidence metric corresponding to a second accuracy of the detection of the object of the image frame. In some implementations, performing the at least one operation includes decoding, using a decoder, a plurality of input frames to obtain the image frame and determine the decoder metric, the decoder metric corresponding to one or more errors or bit allocations of the plurality of input frames.

In some implementations, the processing circuitry is to select a second portion of the portion of the image frame to perform a third inference operation responsive to the at least one quality metric satisfying a second re-inference condition. In some implementations, the processing circuitry is to perform, using the at least one machine learning model, the third inference operation for the second portion of the portion of the image frame.

Some implementation relates to a system including one or more processor. The one or more processor execute operations to determine that at least one quality metric, associated with performing at least one operation on an image frame, satisfies a re-inference condition, the at least one operation corresponding to an image processing pipeline associated with performing a plurality of inference operations on the image frame. The one or more processor execute operations to in response to the determination, perform, using at least one machine learning model, at least one subsequent inference operation of the plurality of inference operations on at least a portion of the image frame identified during at least one previous inference operation of the plurality of inference operations. The one or more processor execute operations to transform at least output data from the plurality of inference operations in a format for at least one of storage or transmission.

In some implementations, the re-inference condition is satisfied based at least on the at least one quality metric exceeding a previous quality metric or exceeding a predefined quality metric threshold. In some implementations, the at least one quality metric includes at least one of (i) a first confidence metric, (ii) a tracking confidence metric, (iii) a second confidence metric, or (iv) a decoder metric. In some implementations, performing the at least one operation includes performing, using the at least one machine learning model, the at least one previous inference operation on the image frame to determine the first confidence metric, the first confidence metric corresponding to a first accuracy of a detection of an object of the image frame.

In some implementations, performing the at least one operation includes generating, using an object tracker, tracking data regarding the object tracked by the object tracker between a first image frame and a second image frame to determine the tracking confidence metric, the tracking confidence metric corresponding to a consistency of the object of the image frame tracked over at least the first image frame and the second image frame. In some implementations, performing the at least one operation includes performing, using the at least one machine learning model, the at least one subsequent inference operation on at least the portion of the image frame to determine the second confidence metric, the second confidence metric corresponding to a second accuracy of the detection of the object of the image frame.

In some implementations, performing the at least one operation includes decoding, using a decoder, a plurality of input frames to obtain the image frame and determine the decoder metric, the decoder metric corresponding to one or more errors or bit allocations of the plurality of input frames. In some implementations, the one or more processors to execute the operations further including select a second portion of the portion of the image frame to perform the one or more subsequent inference operation responsive to the at least one quality metric satisfying a second re-inference condition. In some implementations, the one or more processors to execute the operations further including perform, using the at least one machine learning model, the one or more subsequent inference operation for the second portion of the portion of the image frame.

Some implementation relates to a method. The method includes determining at least one quality metric associated with performing at least one operation on an image frame, the at least one operation corresponding to an image processing pipeline associated with performing, using at least one machine learning model, a first inference operation and a second inference operation on the image frame. The method includes in response to the at least one quality metric satisfying a re-inference condition, performing the second inference operation on a portion of the image frame identified from the first inference operation. The method includes generating a data stream based at least on output data from at least the first inference operation and the second inference operations.

In some implementations, the re-inference condition is satisfied based on the least one quality metric exceeding a previous quality metric or exceeding a predefined quality metric threshold. In some implementations, the at least one quality metric includes at least one of (i) a first confidence metric, (ii) a tracking confidence metric, (iii) a second confidence metric, or (iv) a decoder metric.

The processors, systems, and/or methods described herein can be implemented by or included in at least one a system. The system can include a system for performing simulation operations. The system can include a system for performing collaborative content creation for 3D assets. The system can include a system for generating synthetic data. The system can include a system including one or more vision language models (VLMs). The system can include a system including one or more large language models (LLMs). The system can include a system including one or more small language models (SLMs). The system can include a system including one or more small language models (SLMs). The system can include a system for performing conversational AI operations. The system can include a system for performing light transport simulation. The system can include a system for performing deep learning operations. The system can include a system for performing digital twin operations. The system can include a control system for an autonomous or semi-autonomous machine. The system can include a perception system for an autonomous or semi-autonomous machine. The system can include a system incorporating one or more virtual machines (VMs). The system can include a system implemented using a robot. The system can include a system implemented using an edge device. The system can include a system implemented at least partially in a data center. The system can include a system implemented at least partially using cloud computing resources.

### BRIEF DESCRIPTION OF THE DRAWINGS

The present systems and methods for processing frames in a computer vision pipeline are described in detail below with reference to the attached drawing figures, wherein:

FIG. 1 is a block diagram of an example of a system, in accordance with some implementations of the present disclosure;

FIG. 2 is a flow diagram of an example of a method for selecting and/or performing re-inference in a computer vision pipeline, in accordance with some implementations of the present disclosure;

FIG. 3A is a block diagram of an example generative language model system for use in implementing at least some implementations of the present disclosure;

FIG. 3B is a block diagram of an example generative language model that includes a transformer encoder-decoder for use in implementing at least some implementations of the present disclosure;

FIG. 3C is a block diagram of an example generative language model that includes a decoder-only transformer architecture for use in implementing at least some implementations of the present disclosure;

FIG. 4 is a block diagram of an example computing device for use in implementing at least some implementations of the present disclosure; and

FIG. 5 is a block diagram of an example data center for use in implementing at least some implementations of the present disclosure.

### DETAILED DESCRIPTION

This disclosure relates to systems and methods for dynamic re-inference in various artificial intelligence (AI) pipelines, utilizing improved implementations that enhance inference accuracy and efficiency by selecting high-quality image frames for subsequent inference (e.g., secondary inference, third inference, etc.) based on quality metrics. For example, systems and methods in accordance with the present disclosure facilitate the analysis of image frames by dynamically selecting when to re-infer certain portions, optimizing the processing pipeline.

Some techniques for secondary inference in AI pipelines rely on fixed-interval sampling, which often results in redundant information and misses quality content (e.g., regions within frames containing sharp edges, high contrast, salient objects, complex textures, and/or any dynamic scenes having fast motion) and/or important content (e.g., regions with significant changes in object pose, objects entering or leaving the frame, or any areas indicating occlusion or overlap), leading to inefficient processing and suboptimal analysis. These techniques can fail to provide high-quality insights as they do not adapt to the varying quality and confidence of the data. The limitations relate to how these methods handle re-inference timing, frame quality assessment, and efficiency. For example, fixed-interval sampling can lead to re-inferring portions of frames from low-quality inputs while failing to re-infer from high-quality inputs, resulting in a loss of the quality information and analysis accuracy. Additionally, inadequate re-inference methods can prevent effective processing in implementations that rely on limited computational resources, leading to inefficiencies in analysis tasks.

Systems and methods in accordance with the present disclosure can allow for improved accuracy and efficiency in selecting portions of image frames for re-inference by using a quality-conditioned re-inference model. For example, one or more frames can be evaluated based on quality metric(s) such as primary inference confidence, tracker confidence, secondary inference confidence, and/or bit allocation for detected portions of the frames.

In some implementations, a plurality of frames can be evaluated to determine their quality and relevance. A selection mechanism can be used to determine which portions of the frame should undergo re-inference based on the quality metric(s). In some implementations, the portions satisfying a quality threshold and/or highest-quality portions can be selected for re-inference and stored in a buffer for further analysis. The parameter(s) of the selection mechanism can be updated based on the quality detected in the frames, such as by determining a relevance score based on the parameter(s) and/or metadata. The selected portions can be used to perform analysis, facilitating the input of accurate and relevant data to a subsequent inference system (e.g., a secondary inference system).

In some implementations, the quality metrics of the frames can be used by a crop-selector system. For example, the primary detector confidence, tracker confidence, average bits/MB for the object, and/or previous secondary confidence for the given object can be fed as input to the crop-selector system. Selection criteria or one or more selection parameter(s) can be used to determine which portions of the frame should undergo re-inference based on their quality and relevance. For example, the crop-selector system can select frames where the combined confidence scores exceed a certain threshold. In another example, frames with significant increases in bit allocation for the detected object areas can be prioritized for re-inference. In yet another example, frames with detected objects showing significant motion or activity changes compared to previous frames can be selected for re-inference.

The systems and methods described herein can be used for a variety of purposes, including but not limited to, enhancing image understanding, improving image summarization, and developing real-time processing applications. Moreover, these methods can improve the efficiency of analysis tasks, such as surveillance, sports analytics, and content-based retrieval.

The re-inference method can be used to optimize the input provided to one or more subsequent (e.g., secondary, third, etc.) inference systems in various manners. For example, an analysis of the image content can be extracted from the selected portions and processed to meet performance criteria, such as for real-time analysis applications. Various objectives can be used to facilitate efficient and relevant re-inference, such as to optimize the re-inference for accuracy and computational efficiency.

In some implementations, the systems and methods described herein can be implemented within a simulation environment to evaluate the performance of a computer vision pipeline that includes stages for detection, tracking, re-inference, and encoding. Simulated data (e.g., image frames or video sequences generated by virtual sensors) can be used to test how the system selects specific portions of frames for re-inference based on quality metrics. For example, simulated sensor data can be processed to identify regions within an image frame where re-inference is likely to improve detection accuracy (e.g., areas with low initial confidence scores or inconsistent tracking data). These regions can then be subjected to a secondary inference operation within the simulation environment to assess the effectiveness of the re-inference process. Such simulations can be used to validate the logic for selecting frames or frame portions for re-inference and to optimize the parameter(s) governing this selection before real-world deployment. In some cases, the simulation environment can be utilized to generate synthetic training data consisting of various scenarios where re-inference is needed, which can be used to train or fine-tune machine learning models for improved decision-making in the re-inference process. The simulation environment can also employ rendering techniques, such as ray tracing, to create data that closely resembles real-world conditions. Additionally, the simulation environment can support collaborative development and testing, allowing different components of the computer vision pipeline—such as detectors, trackers, and encoders—to be tested and refined for optimal performance in tasks such as object detection, refinement, and data encoding.

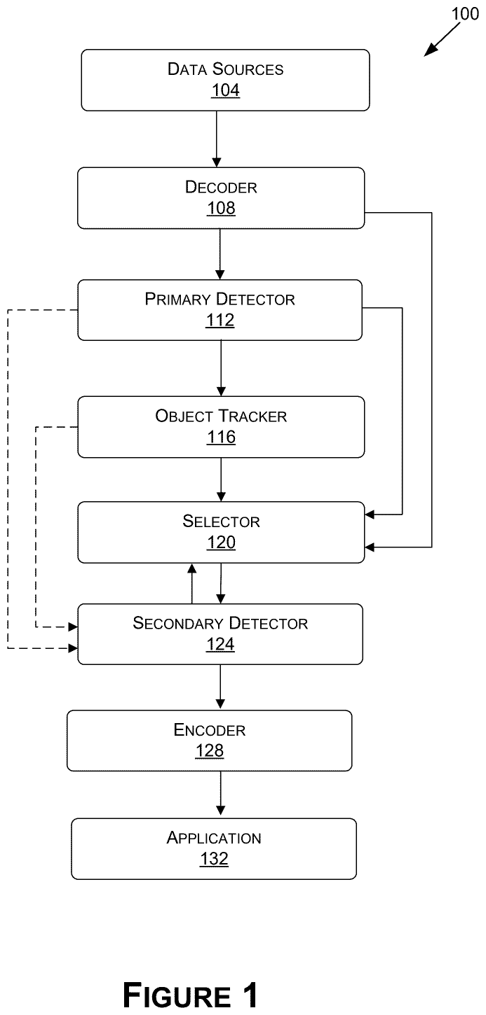

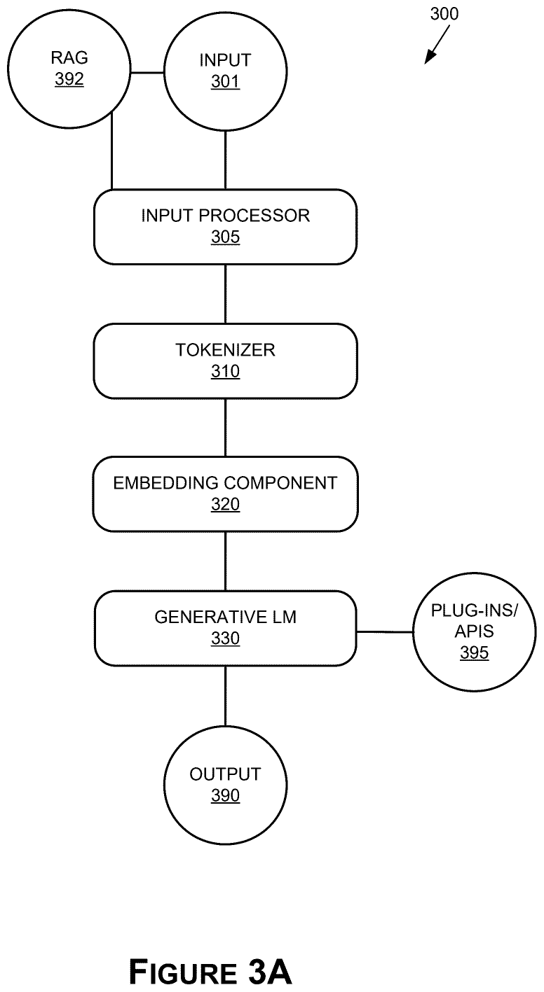

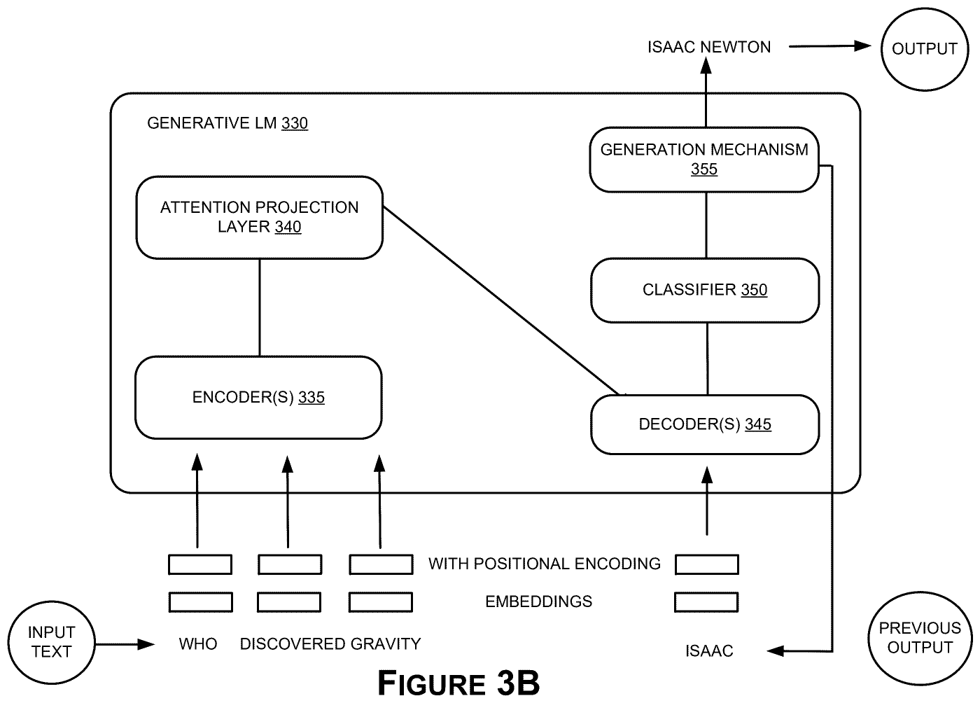

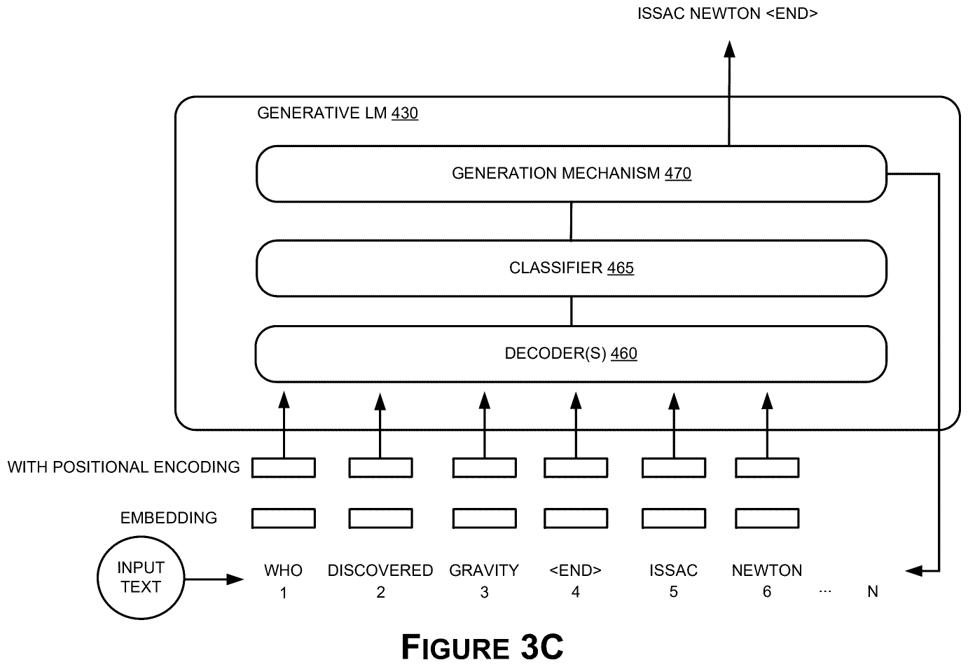

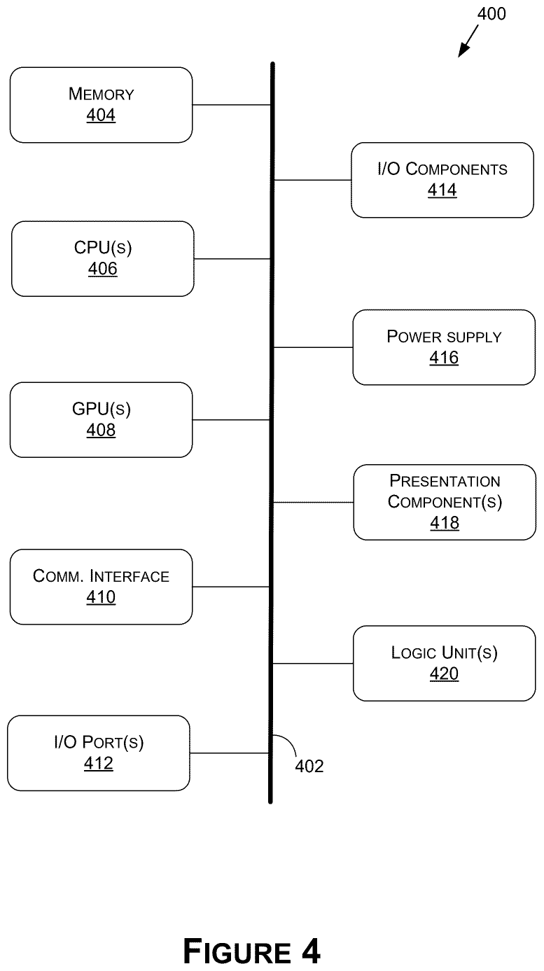

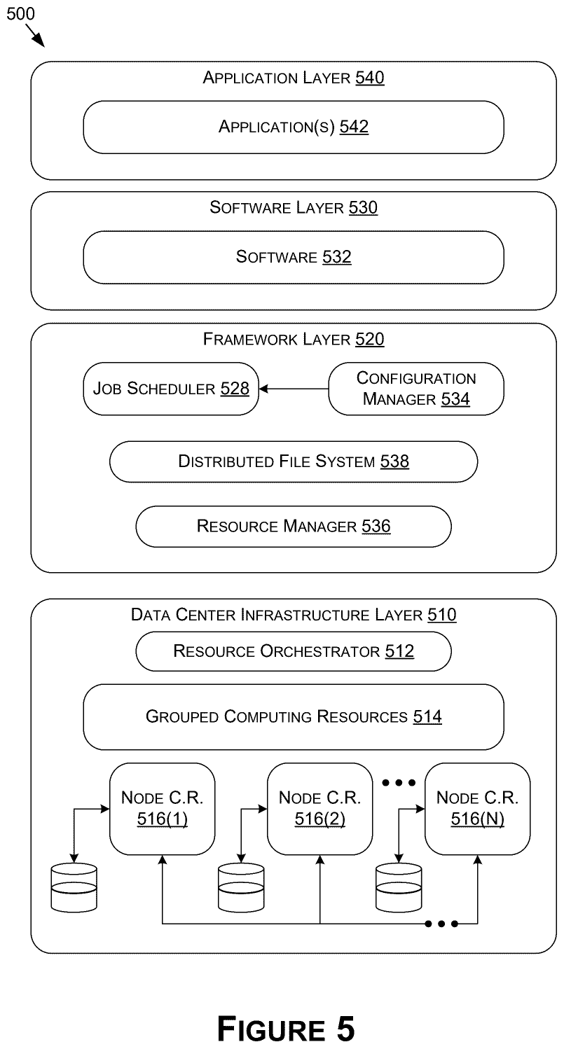

With reference to FIG. 1, FIG. 1 is an example block diagram of a system 100 (e.g., a vision system), in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 300 of FIG. 3A, example generative language model (LM) 330 of FIGS. 3B-3C, example computing device 400 of FIG. 4, and/or example data center 500 of FIG. 5.

The system 100 can implement at least a portion of an artificial intelligence (AI) pipeline, such as a vision AI, computer vision pipeline, or image processing pipeline. For example, the system 100 can process data from one or more data sources 104. The data from the one or more data sources can be representative of a scene and/or one or more objects in the scene for tasks such as object detection, object tracking, and/or object classification. The system 100 can be used to generate data for further processing by any of various systems described herein, including but not limited to autonomous vehicle systems, augmented reality systems, medical imaging systems, industrial automation systems, and/or security surveillance systems.

Generally, the computer vision pipeline (also referred to as an “image processing pipeline”) can include operations performed by the system 100. For example, the computer vision pipeline can include any one or more of a decoding stage, a batching stage, a primary inference stage, a tracking stage, a selection stage, a secondary inference stage, a messaging stage, a compositor stage, an encoding stage, and/or a transmission stage. Each stage of the computer vision pipeline includes one or more components of the system 100 that perform the functions described herein.

The system 100 (e.g., implementing the computer vision pipeline) can dynamically select portions of image frames for subsequent inference (e.g., secondary inference) based on quality metrics, such as previous inference confidence (e.g., primary inference confidence), tracker confidence, and/or bit allocation for detected objects, among other metrics. Additionally, the selection mechanism can prioritize portions of frames for re-inference that exceed a quality threshold or show significant changes in object activity. In some implementations, the re-inference process can be optimized by updating the selection parameter(s) based on the quality detected in the frames. Thus, the computer vision pipeline can improve inference accuracy and efficiency by dynamically selecting high-quality portions for re-inference, reducing redundant processing and optimizing resource allocation.

In some implementations, the decoding stage can be the stage in the computer vision pipeline in which the system 100 prepares encoded image or video data for initial processing and/or quality evaluation. For example, a decoder 108 can convert encoded data into a raw format for generating primary inference outputs and/or quality metrics. For example, the data sources 104 can provide encoded frames in formats such as H.264 or JPEG, which the decoding stage processes to extract pixel-level information. The decoding stage can facilitate accurate primary inference by ensuring that frames are fully reconstructed and/or aligned for subsequent analysis. In some implementations, the decoding stage can perform operations that provide quality metrics, such as determining bit allocation for different frame regions. Additionally, the decoding stage can manage synchronization of frames to maintain data consistency for downstream inference stages. For example, the decoding stage can correct for compression artifacts that can affect the quality assessment and/or re-inference selection.

The system 100 can include or be coupled with at least one data source 104. The data source 104 can include data such as sensor data or image data. The data source 104 can include data from (or implemented or generated by) one or more sensors, such as any one or more cameras (e.g., camera-based autopilot system), LiDAR sensors, radar sensors (e.g., 4D imaging radar sensors), and/or ultrasound sensors. For example, the data source 104 can include data structured as image frames and/or video frames, which can include a plurality of pixels to represent information captured by the respective sensor(s) that outputted the data. The data source 104 can include two-dimensional and/or three-dimensional image data and/or video data.

In some implementations, the data source 104 includes training data (e.g., for training or otherwise updating of primary detector 112, object tracker 116, and/or secondary detector 124). For example, the data source 104 can include one or more example images, at least one (e.g., each) of the one or more example images assigned a label. The label can indicate at least one identifier of an object represented in the example image, such as a bounding box, or a classification (e.g., class, category, type) of the object. The label can include object data such as a region of interest, mask, or metadata. In some implementations, primary detector 112, object tracker 116, and/or secondary detector 124 can be configured based on at least some data other than data of the data source 104. The system 100 can retrieve data from the data source 104 as one or more streams of data. For example, the data can be retrieved according to a streaming protocol, such as a real-time streaming protocol (RTSP). For example, the data can be packetized for transport to and/or within the system 100. The system 100 can retrieve the data at a frame rate. The data from the data source 104 can be encoded, such as to be encoded according to one or more encoding parameters.

In some implementations, the system 100 includes at least one decoder 108. The decoder 108 can apply any of various decoding operations to the data from the data source 104, such as to perform decoding based at least on the one or more encoding parameters. The decoder 108 can include a hardware decoder, such as a hardware accelerator configured to decode the data from the data source 104. The decoder 108 can convert and/or transform the encoded representations of the data into a format that can be processed by one or more components of the system 100, such as the primary detector 112, object tracker 116, and/or secondary detector 124. The decoder 108 can include, without limitation, any one or more of various types of video decoders (e.g., MPEG-4 Part 2, MPEG-4, H.264, H.265) and/or image decoders (e.g., MJPEG, JPEG, PNG, GIF). The decoder 108 can apply reverse compression to the data to reconstruct the frames for modeling (or rendering or displaying). The decoder 108 can compensate for motion vectors used in frames, for example, to reconstruct the frame. The decoder 108 can perform entropy decoding, inverse quantization, inverse transformation, and/or motion compensation, for example.

In some implementations, the primary detector 112 can output one or more quality metrics, which can be associated with the decoding output (e.g., decoded frames, reconstructed image portions). The one or more quality metrics can represent measurements and/or indicators from different stages in the computer vision pipeline that guide a selector 120 in determining further processing steps. For example and without limitation, the quality metrics can include one or more of error information, bits/MB, signal-to-noise ratio (SNR), or peak signal-to-noise ratio (PSNR). For example, the error information can be a quantification of the difference between the original and decoded frames, such as a mean squared error (MSE) value. In this example, the error information can be used to identify frames or portions of frames that can require further processing or re-inference. In other examples, quality metrics such as bits/MB can be outputted to monitor data compression efficiency and to perform frame selection for re-inference. In some implementations, the quality metrics can be provided to the selector 120 to perform re-inference analysis.

Referring further to FIG. 1, the system 100 can perform any of various pre-processing operations on the data from the data source 104 and/or decoded by the decoder 108. For example and without limitation, the system 100 can perform batching, filtering, color detection, grayscale conversion, or various combinations thereof on the data. That is, batching can include aggregating multiple frames or data segments for simultaneous processing to increase throughput in generating and evaluating inference outputs. For example, the decoder 108 can perform batching operations by accumulating frames based on a quality threshold. Additionally, filtering can include applying methods to refine frame data, such as noise reduction or contrast enhancement. For example, the decoder 108 can perform filtering operations to emphasize areas of interest within frames. In some implementations, the decoder 108 can perform color detection operations to isolate specific features or objects of interest. In some embodiments, one or more components of the system 100 other than the decoder 108 can perform the pre-processing operations on the data.

In some implementations, the batching stage can refer to the stage in the computer vision pipeline in which frames can be grouped based on criteria such as quality or relevance. That is, the primary detector 112 can process the batches to detect objects or features efficiently. For example, multiple decoders can output batched frames. The primary detector 112 can adjust its parameters based on the incoming frame data. In some implementations, the primary detector 112 can be configured to prioritize frames with higher potential for accurate detection. Additionally, the batching stage can synchronize frame groups. For example, frames that include similar content changes can be batched for processing.

In some implementations, the primary inference stage can refer to the stage in the computer vision pipeline in which frames are processed to detect objects or features. That is, the primary detector 112 can analyze the frames using trained models to generate detections and associated metrics. For example, the primary detector 112 can identify objects within the frames and output corresponding detection results. The primary inference stage can be configured to adjust detection sensitivity based on frame characteristics. In some implementations, the primary inference stage can use these outputs for further downstream processing. Additionally, the primary inference stage can refine detection results through multi-frame analysis. For example, primary detector 112 can combine data from consecutive frames to stabilize object detection.

The system 100 can include at least one primary detector 112 (also referred to herein as a “primary object detector 112”). The primary detector 112 can include any one or more artificial intelligence models (e.g., machine learning models, supervised models, neural network models, deep neural network models), rules, heuristics, algorithms, functions, or various combinations thereof to perform operations including detecting one or more objects or features of one or more objects from the data, such as from one or more frames of the data. In some implementations, the primary detector 112 can output one or more quality metrics (e.g., primary crop confidence, detection probability, intersection over union (IoU), and/or any error rates) associated with the model output (e.g., bounding boxes, object coordinates). For example, the primary crop confidence can be a metric indicating the reliability of a detected object within a specific region. In other examples, quality metrics such as detection probability, IoU, and error rate can be outputted. In some implementations, the quality metrics can be provided to the selector 120 to perform re-inference analysis.

In some implementations, the primary detector 112 can maintain, execute, train, and/or update one or more machine-learning models during the primary inference stage. In some implementations, the machine-learning model(s) can include any type of object detection (or inference) machine-learning models capable of processing frame data (e.g., image frames) to detect objects. For example, the machine-learning model(s) can be trained and/or updated to process image frame inputs, among other media modalities. The machine-learning model(s) can be or include a transformer-based model (e.g., a generative pre-trained transformer (GPT) model). The machine-learning model(s) can be or include an object detection model, in some implementations. The primary detector 112 can execute the machine-learning model to generate outputs. The primary detector 112 can receive data to provide as input to the machine-learning model(s), which can include frame data.

The primary detector 112 can include at least one neural network. The neural network can include an input layer, an output layer, and/or one or more intermediate layers, such as hidden layers, which can each have respective nodes. The system 100 can configure (e.g., train, update, fine tune, apply transfer learning to) the neural network by modifying or updating one or more parameters, such as weights and/or biases, of various nodes of the neural network responsive to evaluating estimated outputs of the neural network (e.g., generated in response to receiving training data examples). The primary detector 112 can be or include various neural network models, including models that are effective for operating on or generating data including but not limited to image data, video data, text data, speech data, audio data, or various combinations thereof.

In some implementations, the primary detector 112 can be configured (e.g., trained, updated, fine-tuned, has transfer learning performed, etc.) based at least on the training data of the at least one data source 104. For example, one or more example images of the training data can be applied (e.g., by the system 100, or in a pre-training process performed by the system 100 or another system) as input to the primary detector 112 to cause the primary detector 112 to generate an estimated output. The estimated output can be evaluated and/or compared with one or more example labels of the training data that correspond with the one or more example images (e.g., using one or more cost functions, objective functions, scoring functions, and/or gradient functions), and the primary detector 112 can be updated based at least on the evaluation and/or comparison. For example, based at least on an output of an objective function, one or more parameters (e.g., weights and/or biases) of the primary detector 112 can be updated.

Referring further to FIG. 1, the primary detector 112 can receive one or more frames of data (e.g., from data source 104 and/or decoder 108), and can perform object detection (also referred to as an “object inferencing”) on the one or more frames. For example, the primary detector 112 can determine, based at least on a given frame, a representation (or a primary inference) of one or more objects in the given frame. The representation can be analogous to the labels and/or object data assigned to the training data used to configure the primary detector 112. For example and without limitation, the primary detector 112 can determine (or infer) the representation to include information and/or identifiers regarding the one or more objects such as a location, coordinates, bounding element (e.g., bounding box in two or three dimensions) classification (e.g., class, category, type), region of interest, mask, or metadata of the one or more objects. In some implementations, the primary detector 112 outputs at least one of the frame or the representation (e.g., responsive to detection of the one or more objects) or an indication that no object was detected in the frame.

For example, in the primary inference stage, the primary detector 112 can output the frame or the system 100 (or the primary detector 112) can pass the frame for further processing; the primary detector 112 can assign the representation to the frame (e.g., to a data structure including the frame), or, responsive to determining that no objects are in the frame (which can be accurate, or can be due to a failure to detect one or more objects in the frame) can assign an indication to the frame that no objects were detected in the frame. In some implementations, the primary detector 112 stores the output (e.g., inference output, such as the object coordinates) as metadata of the frame.

In some implementations, the tracking stage can refer to the stage in the computer vision pipeline in which detected objects are monitored across frames. That is, the object tracker 116 can use the primary inference output by the primary detector 112 to assign unique tracker identifiers (IDs) to new objects. Additionally, the object tracker 116 can use data from the primary inference stage to follow object movement and maintain identity across frames. For example, the object tracker 116 can utilize techniques such as Kalman filtering to predict object positions in new frames. The tracking stage can manage dynamic changes in object appearance or trajectory. In some implementations, the object tracker 116 can output data used to analyze object behavior or interactions. Additionally, the object tracker 116 can be used to maintain continuity in detection by correcting for missed detections. For example, the object tracker 116 can link detections across frames even when some frames lack clear object visibility.

The system 100 can include at least one object tracker 116. The object tracker 116 can include any one or more artificial intelligence models (e.g., machine learning models, supervised models, neural network models, deep neural network models), rules, heuristics, algorithms, filters (e.g., Kalman filters), functions, or various combinations thereof to perform operations including tracking one or more objects across frames, such as between at least two frames from the data source 104 and/or primary detector 112. In some implementations, the object tracker 116 is trained independently from the primary detector 112. In some implementations, training of the object tracker 116 is at least partially performed jointly with the training of the primary detector 112. In some implementations, the object tracker 116 can output one or more quality metrics (e.g., tracker confidence for crop, tracking accuracy, or any error rate) associated with the decoding output (e.g., object trajectories, bounding boxes). For example, the tracker confidence for crop can be a measure of the certainty that a tracked object remains within a defined area. In other examples, quality metrics such as tracking accuracy and frame-to-frame consistency can be outputted. In some implementations, the quality metrics can be provided to the selector 120 to perform re-inference analysis. That is, the object tracker 116 can generate tracking data regarding the object tracked by the object tracker 116 between a first image frame and a second image frame to determine a tracking confidence metric. For example, the tracking confidence metric can correspond to a consistency (e.g., positional accuracy, trajectory stability) of the object of the image frame tracked over at least the first image frame and the second image frame.

Additionally, the object tracker 116 can generate a track (e.g., tracking data) that includes an identifier of an object. The object tracker 116 can assign a trajectory of the object to the track. The object tracker 116 can assign at least a portion of the output of the primary detector 112 to the track, such as the representation determined (e.g., a primary inference) by the primary detector 112 for the object. In some implementations, the object tracker 116 maintains the track (e.g., in memory) for at least a subset of the frames in which the object is present. The object tracker 116 can generate the tracking data regarding an object tracked by the object tracker 116 between a first frame and a second frame. For example, the object tracker 116 can generate the tracking data by associating the representation of the object in the first frame with a corresponding representation of the object (e.g., generated by the primary detector 112 and/or the object tracker 116) in the second frame.

The object tracker 116 can determine the track to include data regarding the object in a plurality of frames, such as to associate the object in the first frame with the object in the second frame, including, for example, where the second frame is subsequent to and/or consecutive with the first frame. In some implementations, by using the output of the primary detector 112 as an input for performing tracking, the object tracker 116 can have greater accuracy than the primary detector 112 with respect to identifying objects in the frames (e.g., due to the primary detector 112 not having prior information regarding a frame to guide object detection). For example, the object tracker 116 can perform object tracking for the given frame based at least on the output of the primary detector 112 for the given frame, including, for example, based at least on the bounding box and/or object coordinates determined by the primary detector 112 for the given frame.

As noted above, the primary detector 112 can fail to detect one or more objects, in some instances. For example, the primary detector 112 can detect a given object in the first frame, and fail to detect the given object in the second frame. However, the object tracker 116 can identify the given object in the first frame (e.g., based at least on the output that the object detector 112 generates for the first frame), and can identify the given object in the second frame (e.g., based at least on the output that the primary detector 112 generates for the second frame), to track the given object between the first frame and the second frame. For example, the object tracker 116 successfully tracks the given object in the second frame, even where the primary detector 112 fails to track the given object in the second frame. The object tracker 116 can continue to perform data association between detected objects of a new frame (e.g., the second frame) and from previous frames (e.g., the first frame).

In some implementations, the selection stage can refer to the stage in the computer vision pipeline in which frames or portions of frames are identified for additional processing or re-inference based on quality metrics and predefined conditions. That is, the selector 120 can apply predefined criteria to the received metrics to determine whether portions of frames meet the conditions for re-inference by the secondary detector 124. In some implementations, the selector 120 can be configured to operate based on a set of rules or thresholds that prioritize frame portions for re-inference. For example, the selector 120 can obtain a decoder metric from the decoder 108. In another example, the selector 120 can obtain a first confidence metric from the primary detector 112. In yet another example, the selector 120 can obtain a tracking confidence metric from the object tracker 116. In yet another example, the selector 120 can obtain a second confidence metric from the secondary detector 124.

Generally, the selector 120 can receive and/or process multiple quality metrics from different components to assess whether portions of image frames meet the criteria for re-inference. That is, the selector 120 can analyze the decoder metrics from the decoder 108, the confidence metrics from the primary detector 112, the tracking confidence metrics from the object tracker 116, and the confidence metrics from the secondary detector 124 to determine if any frame portions should be processed again by the secondary detector 124. The selector 120 can apply rules or threshold values to at least one (e.g., each) of these metrics to determine if the metrics (alone or in combination) satisfy the conditions set for re-inference.

For example, the selector 120 can use the decoder metric from the decoder 108 to determine if the data quality or bit allocation for a specific frame portion exceeds a predefined value. In this example, if the bit allocation metric increases (e.g., by 10% or by a specified value), indicating that more data is required to maintain fidelity in that portion, the selector 120 can select that frame portion for re-inference. In another example, the selector 120 can analyze the tracking confidence metric from the object tracker 116 to determine if there is a decrease in confidence for tracking an object between frames. In this example, if the tracking confidence metric falls below a certain threshold—indicating instability or potential loss of the tracked object—the selector 120 can select the corresponding frame portion for re-inference by the secondary detector 124 to refine the detection or regain tracking confidence.

In yet another example, the selector 120 can analyze a combination of the tracking confidence metric from the object tracker 116 and the confidence metric from the primary detector 112 to determine if re-inference should be performed. In this example, the selector 120 can compare the tracking confidence metric to a predefined threshold and evaluate the confidence metric to assess detection certainty. If the tracking confidence metric indicates instability in the tracked path of the object and the confidence metric shows a decrease in the classification certainty of the detected object, the selector 120 can select the associated frame portion for re-inference by the secondary detector 124. In yet another example, the selector 120 can utilize weighting to model multiple quality metrics from the decoder 108, primary detector 112, object tracker 116, and/or secondary detector 124 to determine re-inference requirements. In this example, the selector 120 can assign different weights to each metric, such as higher weights to the primary confidence metric and tracking confidence metric and lower weights to the decoder metric and secondary confidence metric, based on the relative importance (e.g., which can be application or implementation specific) in maintaining accurate object detection and tracking. The selector 120 can compute a weighted score for at least one (e.g., each) frame portion by aggregating the weighted metrics. If the aggregated score exceeds a predetermined threshold, the selector 120 can identify the corresponding frame portion for re-inference by the secondary detector 124.

In some implementations, ensemble voting for re-inference can be implemented by deploying multiple decision models within the selector 120, at least one (e.g., each) configured to process input quality metrics from the decoder 108, primary detector 112, object tracker 116, and/or secondary detector 124. The selector 120 can aggregate the output from at least one (e.g., each) model and perform a voting mechanism to determine a secondary re-inference decision. Clustering can be implemented by the selector 120 computing feature vectors from the quality metrics and applying clustering algorithms to segment the frame portions into groups. The selector 120 can then identify clusters meeting specific criteria for re-inference. In some implementations, adaptive thresholds can be implemented by the selector 120 to continuously monitor incoming quality metrics and calculate updated thresholds using sliding window techniques or exponential smoothing, dynamically adjusting re-inference criteria without manual recalibration. Additionally, multi-criteria decision analysis (MCDA) can be employed. For example, the selector 120 can implement Pareto optimization to identify non-dominated frame portions that maximize multiple quality metrics simultaneously. The selector 120 can use rule-based decision trees where each node can represent a decision criterion based on a combination of quality metrics, which can allow the selector 120 to model and/or select frame portions that meet multi-dimensional criteria for re-inference.

In some implementations, the selector 120 can utilize one or more quality metrics to determine which frames or frame portions to re-inference. For example, the selector 120 can compare current confidence metrics to previous confidence metrics to evaluate if re-inference conditions are satisfied. In another example, the selector 120 can utilize metrics related to object movement or changes in object appearance to identify portions where re-inference can be performed. As shown, re-inference can be performed by the secondary detector 124 when the quality metrics meet specified thresholds or changes in threshold values from previous frame are identified.

In some implementations, the selector 120 can determine at least one quality metric (e.g., primary confidence score from primary detector 112, bit allocation from decoder 108, tracker confidence from object tracker 116, and/or secondary confidence score from secondary detector 124) associated with performing at least one operation on an image frame. That is, the at least one operation can correspond to a computer vision pipeline (or an image processing pipeline) associated with performing a first inference operation (e.g., by primary detector 112, the first inference operation as referred to herein as “at least one previous interference operation”) and a second inference operation (e.g., by secondary detector 124, the second inference operation as referred to herein as “at least one subsequent interference operation”) on the image frame. For example, the quality metric can include, but is not limited to, a first confidence metric, a tracking confidence metric, a second confidence metric, and/or a decoder metric. For example, the primary detector 112 can output a first confidence metric. In this example, the first confidence metric can be a numerical score or value indicating the certainty of the detected classification of the object or spatial location. In another example, the object tracker 116 can output a tracking confidence metric. In this example, the tracking confidence metric can be a numerical score or value indicating the stability of the path of the object or motion model. In yet another example, the secondary detector 124 can output a second confidence metric. In this example, the second confidence metric can be a numerical score or value indicating the refinement accuracy over the initial detection. In yet another example, the decoder 108 can output a decoder metric.

In some implementations, the selector 120 can identify a portion of the image frame (e.g., crop, segment, and/or region of interest) for the second inference operation when at least one quality metric satisfies a re-inference condition (e.g., criteria for selecting re-inference). That is, the re-inference condition can be met when at least one quality metric exceeds a previous quality metric (e.g., an increase in detection confidence score and/or tracking consistency score) or surpasses a predefined quality metric threshold (e.g., 10% threshold, comparison between previous primary inference confidence and current primary inference confidence, such as 90% vs. 99%). For example, if the confidence level of the same detected object from the primary inference exceeds its previous confidence level (e.g., by 10% or any defined threshold), then the detected object by the primary detector 112 and/or object tracker 116 can be processed using the secondary detector 124 (e.g., for re-inference). In another example, if the object detection region shows significant variation in terms of quality metrics (e.g., bit allocation or clarity), then that region can be selected for re-inference using the secondary detector 124. In another example, if the tracking confidence score indicates instability or sudden changes in object movement, then the detected object by the primary detector 112 and/or object tracker 116 can be re-inferenced using the secondary detector 124. In some implementations, the thresholds for re-inference can be customized, set, and/or re-configured based on application-specific requirements, accuracy levels, or operational parameters.

In some implementations, the secondary inference stage can refer to the stage in the computer vision pipeline in which the secondary detector 124 can perform, using at least one machine learning model, the second inference operation for the portion of the image frame. That is, in response to the determination and/or selection of a portion of the image, the secondary detector 124 can perform, using at least one machine learning model, at least one subsequent inference operation of the plurality of inference operations on at least a portion of the image frame identified during at least one previous inference operation of the plurality of inference operations. For example, the secondary detector 124 can process portions of frames identified by the primary detector 112 to perform refined inference and produce outputs for encoding by the encoder 128. In this example, the secondary detector 124 can analyze specific regions to provide more granular classifications (e.g., identifying subtypes or categories within a detected object, detecting specific object attributes, recognizing changes in object properties or states). In some implementations, in response to the at least one quality metric satisfying a re-inference condition, the secondary detector 124 can perform the second inference operation on a portion of the image frame identified from the first inference operation. That is, the secondary inference stage can produce outputs for encoding or transmission. Additionally, the secondary inference stage can improve the detail and accuracy of the data before encoding.

The system 100 can include at least one secondary detector 124 (also referred to herein as a “secondary object detector 124”). The secondary detector 124 can include any one or more artificial intelligence models (e.g., machine learning models, supervised models, neural network models, deep neural network models), rules, heuristics, algorithms, functions, or various combinations thereof to perform operations including refining detections or providing additional details for one or more objects in one or more frames of the data. In some implementations, the secondary detector 124 is trained independently from the primary detector 112 and/or the object tracker 116. In some implementations, the secondary detector 124 is the primary detector 112. In some implementations, the secondary detector 124 is similarly configured as the primary detector 112. In some implementations, training of the secondary detector 124 is at least partially performed jointly with the training of the primary detector 112 and/or the object tracker 116. In some implementations, the secondary detector 124 can output results (e.g., refined bounding boxes, detailed object classifications) that are subsequently processed by the encoder 128 for storage, transmission, or further use. For example, the secondary detector 124 can refine the boundaries or classifications of detected objects within specific regions to enhance the quality of the encoded data. In other examples, refined outputs can include object representations that can be compressed or transmitted.

In some implementations, the secondary detector 124 can maintain, execute, train, and/or update one or more machine-learning models during the secondary inference stage. In some implementations, the machine-learning model(s) can include any type of object detection (or inference) machine-learning models capable of processing frame data (e.g., image frames) to refine objects or provide further details. The machine-learning model(s) can be trained and/or updated to provide classifications or to process objects in the frame data that require additional analysis beyond the initial inference (e.g., detection). The machine-learning model(s) can be or include a transformer-based model (e.g., a generative pre-trained transformer (GPT) model). The machine-learning model(s) can be or include an object detection model, in some implementations. The secondary detector 124 can execute the machine-learning model to generate refined outputs (e.g., detected objects). The secondary detector 124 can receive data to provide as input to the machine-learning model(s), which can include regions or portions of frame data identified by the primary detector 112.

The secondary detector 124 can include at least one neural network. The neural network can include an input layer, an output layer, and/or one or more intermediate layers, such as hidden layers, which can each have respective nodes. The system 100 can configure (e.g., train, update, fine-tune, apply transfer learning to) the neural network by modifying or updating one or more parameters, such as weights and/or biases, of various nodes of the neural network based on evaluating estimated outputs of the neural network (e.g., generated in response to receiving training data examples). The secondary detector 124 can be or include various neural network models, including models that are effective for operating on or generating data including but not limited to image data, video data, text data, speech data, audio data, or various combinations thereof.

In some implementations, the secondary detector 124 can be configured (e.g., trained, updated, fine-tuned, or has transfer learning performed) based at least on the training data of the at least one data source 104 and/or derived from outputs of the primary detector 112 and/or the object tracker 116. For example, one or more example images of the training data can be applied (e.g., by the system 100 or in a pre-training process performed by the system 100 or another system) as input to the secondary detector 124 to cause the secondary detector 124 to generate a refined output. The refined output can be evaluated and/or compared with one or more example labels of the training data that correspond with the example images (e.g., using one or more cost functions, objective functions, scoring functions, and/or gradient functions), and the secondary detector 124 can be updated based on the evaluation and/or comparison. For example, based at least on an output of an objective function, one or more parameters (e.g., weights and/or biases) of the secondary detector 124 can be updated.

Referring further to FIG. 1, the secondary detector 124 can receive one or more portions of frames of data (e.g., indirectly from the primary detector 112 and/or object tracker 116 via the selector 120 or directly from the primary detector 112 or object tracker 116), and can perform object re-inference (also referred to as a “secondary object inferencing”) on the selected portions. That is, in response to the determination, the secondary detector 124 can perform, using at least one machine learning model, at least one subsequent inference operation on at least a portion of the image frame identified during at least one previous inference operation of the plurality of inference operations, without explicit selection by the selector 120. Thus, it should be understood that either the selector 120 can select the portion for re-inference, or the secondary detector 124 can directly perform re-inference based on outputs from the primary detector 112 or object tracker 116. For example, the secondary detector 124 can automatically re-infer regions where the primary detector 112 shows an increase in detection confidence. In another example, the selector 120 can identify specific regions for re-inference based on a threshold comparison between current and previous confidence scores. In yet another example, the secondary detector 124 can perform re-inference on portions selected by the selector 120 when a quality metric, such as a tracking confidence score, satisfies a re-inference condition (e.g., significant drop in tracking consistency).

In some implementations, the secondary detector 124 can determine, based at least on a given portion of a frame, a refined representation (or a secondary inference) of one or more objects in that portion. The refined representation can provide more detailed information or classifications related to the labels and/or object data assigned by the primary detector 112. For example and without limitation, the secondary detector 124 can determine (or infer) the refined representation to include additional identifiers regarding the one or more objects such as specific types, sub-categories, detailed regions of interest, masks, or metadata of the objects. In some implementations, the secondary detector 124 outputs the refined portion to the encoder 128 or assigns the refined representation to the frame portion (e.g., to a data structure including the portion).

For example, in the secondary inference stage, the secondary detector 124 can output the refined portion to the encoder 128 for encoding; the secondary detector 124 can assign the refined representation to the frame portion (e.g., to a data structure including the portion), or, responsive to determining that no further refinement is required for the object in the portion, can assign an indication to the frame portion that no additional information was extracted. In some implementations, the secondary detector 124 stores the output (e.g., refined inference output, such as detailed object coordinates) as metadata of the frame portion, which is then used by the encoder 128 for subsequent processing.

In some implementations, the messaging stage can refer to the stage in the computer vision pipeline in which data, including refined inferences and detection outputs, is prepared for subsequent processing or transmission. The system 100 can include or be coupled with at least one encoder 128. That is, at least one encoder 128 can manage the transformation (e.g., formatting and/or packaging) of data for encoding or transmission. For example, the encoder 128 can handle the arrangement of output data from the primary detector 112, object tracker 116, and/or secondary detector 124 into a structured format for encoding. The messaging stage can include organizing data streams and processing metadata that accompanies the processed data. In some implementations, the encoder 128 can facilitate the messaging stage by controlling the flow and order of data. Additionally, the messaging stage can include error detection mechanisms or checksums to facilitate data integrity checks before encoding. For example, data integrity checks can be performed to identify and flag any corrupted data packets prior to encoding or transmission.

In some implementations, the compositor stage can refer to the stage in the computer vision pipeline in which multiple streams or layers of processed data are combined into at least one composite output. That is, the at least one encoder 128 can merge various processed outputs (e.g., object detection data, tracking data, refined inference data) into a unified data stream. For example, the encoder 128 can integrate visual data from multiple detectors and trackers into at least one encoded video stream. In some implementations, the encoder 128 can facilitate the compositor stage by synchronizing different data types (e.g., video and metadata) to maintain temporal coherence.

In some implementations, the encoding stage can refer to the stage in the computer vision pipeline in which the composite data prepared by the messaging and compositor stages is converted into a compressed format for storage or transmission. That is, at least one encoder 128 can apply compression algorithms to reduce data size while preserving critical information. For example, the encoder 128 can encode the data using standards like H.264 or H.265 to generate efficient bitstreams. In some implementations, the encoding stage can update encoding parameters based on the content characteristics or network conditions.

The encoder 128 can encode (e.g., compress) data outputted by the primary detector 112, the object tracker 116, the secondary detector 124, and/or one or more other components of the system 100. That is, the encoder 128 can transform at least output data from the plurality of inference operations in a format for at least one of storage or transmission. For example, the encoder 128 can convert object detection data into an MPEG-4 format for transmission to downstream systems. In another example, the encoder 128 can use one or more algorithms to reduce a file size of the data. In some implementations, the encoder 128 can use one or more of the same encoding parameters (e.g., resolution, video file format) as the encoding of the data of the data source 104, such as encoding parameters based on which the decoder 108 decoded the data from the data source 104. The encoder 128 can generate and/or compress bitstreams of data. In some implementations, the encoder 128 can generate a data stream based at least on output data from at least the first inference operation and the second inference operations. That is, the encoder 128 can aggregate and compress data streams from multiple inference stages into a unified output format for handling. For example, the encoder 128 can combine refined object detection results from the secondary detector 124 with tracking information from the object tracker 116 into a single compressed stream for real-time video analytics. In some implementations, the encoder 128 can compress raw image and/or video content into formats for storage and transmission, using standards like H.264, H.265 (HEVC), or VP9. The encoder 128 can be used to facilitate streaming the outputs from the system 100, such as to allow the system 100 to operate as a module or system in an overall data processing pipeline from the data sources 104 to application 132.

In some implementations, the transmission stage can refer to the stage in the computer vision pipeline in which encoded data packets are transmitted to downstream applications or storage systems. That is, at least one encoder 128 can transmit packets (e.g., via a network or any other communication channels) of data packetized by the encoder 128 to the application 132. For example, the encoder 128 can manage network protocols and buffer controls. The transmission stage can handle network conditions like latency and packet loss to maintain transmission integrity. In some implementations, the transmission stage can support retransmission of lost packets.

The system 100 can include or be coupled with at least one application 132. The application 132 can be a consumer of the object detection data outputted by the primary detector 112 and/or secondary detector 124, and/or the tracking data outputted by the object tracker 116. In some implementations, the application 132 transmits a request for retrieval of data from the system 100, such as from one or more of the primary detector 112, the object tracker 116, and/or secondary detector 124. In some implementations, the system 100 includes a message broker to manage communication of data with the application 132 (e.g., during the transmission stage, the encoder 128). The application 132 can perform operations on the data including but not limited to perception, sensor fusion, vehicle control, or image and/or video display tasks.

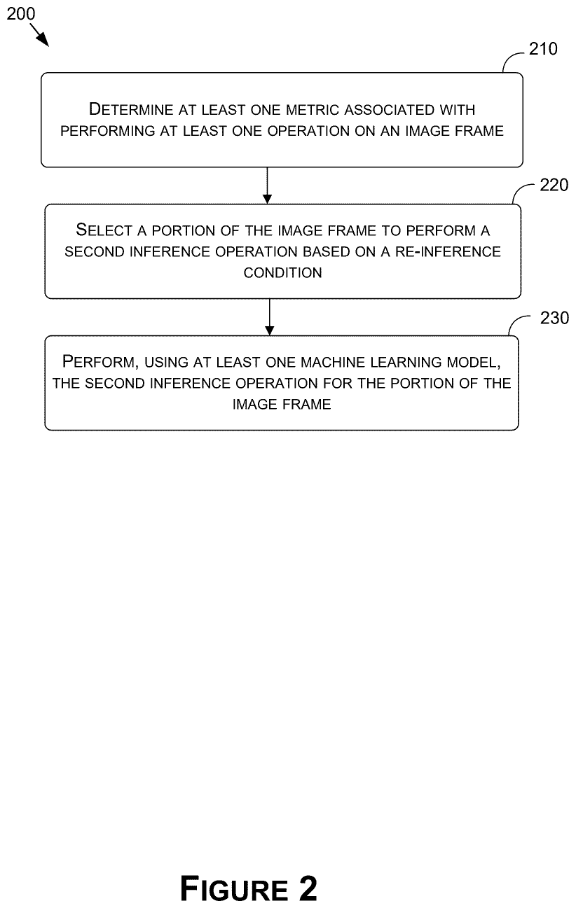

With reference to FIG. 2, an example flow diagram illustrating a method for selecting and performing re-inference in a computer vision pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 3A-3C), one or more computing devices or components thereof (e.g., as described in FIG. 4), and/or one or more data centers or components thereof (e.g., as described in FIG. 5).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for determining, selecting, and performing re-inference operations, in accordance with some implementations of the present disclosure. Various operations of method 200 can relate to improving the efficiency and accuracy of computer vision pipelines by optimizing re-inference based on dynamic quality metrics. Existing systems often rely on static thresholds or fixed-interval re-inference, which can lead to redundant processing or missed opportunities for refinement. The existing technological problems can arise when these systems fail to adapt to varying data quality and/or fluctuating object movement patterns, resulting in suboptimal use of computational resources and inaccurate detections. Method 200 of FIG. 2 can solve these technological problems by implementing a selection mechanism that evaluates multi-dimensional quality metrics and adapts re-inference criteria in real-time (or near real-time), thereby enhancing both the precision and efficiency of the inference process.

The method 200, at block 210, includes determining at least one quality metric associated with performing at least one operation on an image frame, the at least one operation corresponding to an image processing pipeline (e.g., vision AI pipeline and/or computer vision pipeline) associated with performing a first inference operation and, optionally, one or more subsequent inference operations (e.g., a second inference operation, etc.) on the image frame. That is, the processing circuits can determine that at least one quality metric, associated with performing at least one operation on an image frame, satisfies a re-inference condition, the at least one operation corresponding to an image processing pipeline associated with performing a plurality of inference operations on the image frame. Additionally, the image processing pipeline can correspond with performing an interference operation using at least one machine learning model. In some implementations, determining a metric can include analyzing outputs from one or more components or machine learning models, aggregating scores from object detectors, trackers, or decoders, and/or computing quality indicators from these outputs. For example, determining a primary confidence score can include calculating a classification probability or bounding box accuracy. That is, performing an operation can include executing neural network-based object detection or object tracking algorithms. For example, the first inference operation can be a primary inference and the second inference operation can be a secondary inference. Additionally, the at least one quality metrics can be, but is not limited to, primary confidence scores, bit allocations, tracker confidences, and/or secondary confidence scores.

In some implementations, the at least one quality metric can include at least one of (i) a first confidence metric, (ii) a tracking confidence metric, (iii) a second confidence metric, or (iv) a decoder metric. That is, the processors can use confidences and quality scores to select portions for re-inference (e.g., at block 220). For example, the selector can model one or more confidence scores and/or metrics and adjust the priority for re-inference based on the variance or drop in scores across one or more frames (e.g., consecutive frames). In some implementations, performing the at least one operation can include performing, using the at least one machine learning model, the first inference operation on the image frame to determine the first confidence metric. For example, the first confidence metric can correspond to a first accuracy of a detection of an object of the image frame. That is, the first accuracy of a detection can be derived from an object detection model (e.g., CNN to generate probabilities and bounding box coordinates for detected objects)

In some implementations, performing the at least one operation can include generating, using an object tracker, tracking data regarding the object tracked by the object tracker between a first image frame and a second image frame to determine the tracking confidence metric. For example, the tracking confidence metric can correspond to a consistency of the object of the image frame tracked over at least the first image frame and the second image frame. That is, the consistency of the object of the image frame can be calculated (e.g., using Kalman filter residuals or Intersection over Union (IoU) scores) for bounding boxes across frames. In some implementations, performing the at least one operation can include performing, using the at least one machine learning model, the second inference operation on the portion of the image frame to determine the second confidence metric. For example, the second confidence metric can correspond to a second accuracy of the detection of the object of the image frame. In some implementations, performing the at least one operation can include decoding, using a decoder, a plurality of input frames to obtain the image frame and determine the decoder metric. For example, the decoder metric can correspond to one or more errors or bit allocations of the plurality of input frames. That is, the errors or bit allocations can be determined by computing an average bits per pixel (BPP) or distortion measures (e.g., mean squared error).

The method 200, at block 220, includes selecting a portion of the image frame to perform the second inference operation responsive to the at least one quality metric satisfying a re-inference condition. In some implementations, in response to the determination, the processing circuits can perform, using at least one machine learning model, at least one subsequent inference operation of the plurality of inference operations on at least a portion of the image frame identified during at least one previous inference operation of the plurality of inference operations (described in detail with reference to block 230). That is, the portion of the image frame can be a crop (e.g., a region of interest containing a detected object where quality metrics indicate further analysis). The crop can be selected based on a combination of confidence scores and spatial parameters indicating regions where, for example, refined inference can output more accurate or detailed information. For example, a region can be selected where there is a significant increase in confidence scores from the primary detector 112 or where higher bit allocation from the decoder 108 suggests improved data fidelity in the region.

Additionally, satisfying a re-inference condition can include criteria or a heuristic for selecting a re-inference. For example, the re-inference condition can be satisfied based on at least one quality metric exceeding a previous quality metric (e.g., an increase in detection confidence score and/or bit allocation quality) or surpassing a predefined quality metric threshold (e.g., a 10% improvement in confidence between previous primary inference and current primary inference). In this example, exceeding the previous quality metric can include identifying regions where confidence scores have increased above a threshold, indicating enhanced detection reliability or clarity. Additionally, exceeding the predefined quality metric threshold can include setting dynamic thresholds that adjust to the current context of the frame, such as higher thresholds in low-confidence environments to prioritize more confident detections. In this example, exceeding the previous quality metric can include tracking changes in confidence over multiple frames to identify spikes or drops that indicate instability. Additionally, exceeding the predefined quality metric threshold can include establishing dynamic thresholds based on scene complexity or environmental conditions.

The method 200, at block 230, includes performing, using at least one machine learning model, the second inference operation for the portion of the image frame. That is, the processors can selectively perform the re-inference based on the updated quality metrics derived from previous stages and/or previous re-inference. For example, in response to the determination and/or the selection, the processing circuits can perform, using at least one machine learning model, at least one subsequent inference operation of the plurality of inference operations on at least a portion of the image frame identified during at least one previous inference operation of the plurality of inference operations (described in detail with reference to block 230). In some implementations, in response to the at least one quality metric satisfying a re-inference condition, the processing circuits can perform the second inference operation on a portion of the image frame identified from the first inference operation. The re-inference operation can include re-analyzing selected portions to refine object detection or classification outputs where confidence has increased or data quality has improved. For example, the secondary detector 124 can apply a model or higher-resolution processing to the selected portion if the primary detector 112 shows an increased confidence score for a particular detected object. This targeted re-inference can provide more detailed outputs, such as refined bounding boxes, classifications, or object states, which can be prepared for encoding or further processing by the encoder 128.

In some implementations, method 200 can further include selecting a second portion of the portion of the image frame to perform a third inference operation responsive to the at least one quality metric satisfying a second re-inference condition. That is, a more granular region within an already selected portion can be identified for additional processing when the re-inference metrics indicate further potential for enhanced detail or accuracy. For example, the second portion can be selected where an increase in secondary confidence metrics suggests more detailed refinement is possible. Additionally, the processors can perform, using the at least one machine learning model, the third inference operation for the second portion of the portion of the image frame. That is, the third inference can use one or more models or algorithms, such as models trained for fine-grained feature recognition or state detection, triggered when previous re-inference results satisfy one or more quality thresholds or improvements.

In some implementations, method 200 can further include transforming at least output data from the plurality of inference operations in a format for at least one of storage or transmission. That is, the processing circuits can compress and encode the output data from the inference operations into a suitable format for efficient storage or transmission. For example, the processing circuits can apply a specific compression algorithm (e.g., H.264 or H.265) to reduce the data size while maintaining object detection details. In another example, the processing circuits can encode metadata, such as object classifications or tracking data, in the primary data stream for downstream applications. Additionally, transforming can include organizing the output data into packets suitable for network transmission.

In some implementations, method 200 can further include generating a data stream based at least on output data from at least the first inference operation and the second inference operations. That is, the processing circuits can aggregate and format the output of both primary and secondary inferences into a unified data stream. For example, the processing circuits can combine object detection outputs from the primary detector with refined details from the secondary detector to create a stream for further processing or display. In another example, the data stream can include both visual data and metadata, such as tracking confidence or detection scores, to facilitate integration with external systems. Additionally, generating the data stream can include applying error correction protocols or algorithms.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can perform the operations of components such as the primary detector 112, object tracker 116, selector 120, and/or secondary detector 124 within a computer vision pipeline. That is, these models can directly handle tasks such as object detection, tracking, and the selection of image frame portions for re-inference by analyzing data, generating confidence scores, or computing quality metrics. For example, the primary detector 112 can utilize a language model to detect objects within frames, while the selector 120 can use a language model to determine which portions of frames should undergo re-inference based on calculated quality metrics. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases) - such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 3A is a block diagram of an example generative language model system 300 for use in implementing at least some implementations of the present disclosure. In the example illustrated in FIG. 3A, the generative language model system 300 includes a retrieval augmented generation (RAG) component 392, an input processor 305, a tokenizer 310, an embedding component 320, plug-ins/APIs 395, and a generative language model (LM) 330 (which can include an LLM, a VLM, a multi-modal LM, etc.). Generally, the example generative language model system 300 can perform operations for components within a computer vision pipeline, such as object detection, tracking, and selecting portions of image frames for re-inference. That is, the generative language model (LM) 330, in conjunction with other components, performs processing tasks by analyzing data inputs, generating embeddings, and determining outputs, such as e.g., confidence scores or quality metrics. For example, the LM 330 can process incoming frame data to detect objects, the RAG component 392 can retrieve additional context to enhance detection or tracking, and the selector 120 (not shown) can use outputs from these components to make decisions about re-inference operations.

At a high level, the input processor 305 can receive an input 301 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 330 (e.g., LLM/VLM/MMLM/etc.). In some implementations, the input 301 includes plain text in the form of one or more sentences, paragraphs, and/or documents. Additionally or alternatively, the input 301 can include numerical sequences, precomputed embeddings (e.g., word or sentence embeddings), and/or structured data (e.g., in tabular formats, JSON, or XML). In some implementations in which the generative LM 330 is capable of processing multi-modal inputs, the input 301 can combine text (or can omit text) with image data, audio data, video data, design data, USD data, and/or other types of input data, such as but not limited to those described herein. Taking raw input text as an example, the input processor 305 can prepare raw input text in various ways. For example, the input processor 305 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 305 can remove stopwords to reduce noise and focus the generative LM 330 on more meaningful content. The input processor 305 can apply text normalization, for example, by converting all characters to lowercase, removing accents, and/or or handling special cases like contractions or abbreviations to ensure consistency. These are just a few examples, and other types of input processing can be applied.

In some implementations, a RAG component 392 (which can include one or more RAG models, and/or can be performed using the generative LM 330 itself) can be used to retrieve additional information to be used as part of the input 301 or prompt. RAG can be used to enhance the input to the LLM/VLM/MMLM/etc. with external knowledge, so that answers to specific questions or queries or requests are more relevant—such as in a case where specific knowledge is required. The RAG component 392 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 301 can be generated using the query or input to the model (e.g., a question, a request, etc.) in addition to data retrieved using the RAG component 392. In some implementations, the input processor 305 can analyze the input 301 and communicate with the RAG component 392 (or the RAG component 392 can be part of the input processor 305, in implementations) in order to identify relevant text and/or other data to provide to the generative LM 330 as additional context or sources of information from which to identify the response, answer, or output 390, generally. For example, where the input indicates that the user is interested in a desired tire pressure for a particular make and model of vehicle, the RAG component 392 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 392 can retrieve a prior stored conversation history—or at least a summary thereof—and include the prior conversation history along with the current ask/request as part of the input 301 to the generative LM 330.

The RAG component 392 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 392 and the embeddings of the chunks along with the embeddings of the query can be compared to identify the most similar/related embeddings to the query, which can be supplied to the generative LM 330 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 392 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 310 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 330 to understand morphological variations and handle out-of-vocabulary words more effectively. Character-based tokenization represents each character as a separate token, enabling the generative LM 330 to process text at a fine-grained level. The choice of tokenization strategy can depend on factors such as the language being processed, the task at hand, and/or characteristics of the training dataset. As such, the tokenizer 310 can convert the (e.g., processed) text into a structured format according to tokenization schema being implemented in the particular implementation.

The embedding component 320 can use any known embedding technique to transform discrete tokens into (e.g., dense, continuous vector) representations of semantic meaning. For example, the embedding component 320 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 301 includes image data/video data/etc., the input processor 301 can resize the data to a standard size compatible with format of a corresponding input channel and/or can normalize pixel values to a common range (e.g., 0 to 1) to ensure a consistent representation, and the embedding component 320 can encode the image data using any known technique (e.g., using one or more convolutional neural networks (CNNs) to extract visual features). In some implementations in which the input 301 includes audio data, the input processor 301 can resample an audio file to a consistent sampling rate for uniform processing, and the embedding component 320 can use any known technique to extract and encode audio features—such as in the form of a spectrogram (e.g., a mel-spectrogram). In some implementations in which the input 301 includes video data, the input processor 301 can extract frames or apply resizing to extracted frames, and the embedding component 320 can extract features such as optical flow embeddings or video embeddings and/or can encode temporal information or sequences of frames. In some implementations in which the input 301 includes multi-modal data, the embedding component 320 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 330 and/or other components of the generative LM system 300 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 320 can apply an encoded representation of the input 301 to the generative LM 330, and the generative LM 330 can process the encoded representation of the input 301 to generate an output 390, which can include responsive text and/or other types of data.

As described herein, in some implementations, the generative LM 330 can be configured to access or use—or capable of accessing or using—plug-ins/APIs 395 (which can include one or more plug-ins, application programming interfaces (APIs), databases, data stores, repositories, etc.). For example, for certain tasks or operations that the generative LM 330 is not ideally suited for, the model can have instructions (e.g., as a result of training, and/or based on instructions in a given prompt, such as those retrieved using the RAG component 392) to access one or more plug-ins/APIs 395 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 395 to the plug-in/API 395, the plug-in/API 395 can process the information and return an answer to the generative LM 330, and the generative LM 330 can use the response to generate the output 390. This process can be repeated - e.g., recursively—for any number of iterations and using any number of plug-ins/APIs 395 until an output 390 that addresses each ask/question/request/process/operation/etc. from the input 301 can be generated. As such, the model(s) can not only rely on its own knowledge from training on a large dataset(s) and/or from data retrieved using the RAG component 392, but also on the expertise or optimized nature of one or more external resources - such as the plug-ins/APIs 395.

FIG. 3B is a block diagram of an example implementation in which the generative LM 330 includes a transformer encoder-decoder. For example, assume input text such as “Who discovered gravity” is tokenized (e.g., by the tokenizer 310 of FIG. 3A) into tokens such as words, and each token is encoded (e.g., by the embedding component 320 of FIG. 93A) into a corresponding embedding (e.g., of size). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 335 of the generative LM 330. Generally, the generative LM 330 can be used to analyze and process image frame data for tasks such as detection, tracking, and re-inference. That is, it can generate contextual embeddings that assist in determining quality metrics or selecting portions of frames for re-inference in the computer vision pipeline.

In an example implementation, the encoder(s) 335 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 340 can convert the context vector into attention vectors (keys and values) for the decoder(s) 345.

In an example implementation, the decoder(s) 345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 335, in an example transformer architecture, each token (e.g., word) flows through a separate path in the decoder(s) 345. During a first pass, the decoder(s) 345, a classifier 350, and a generation mechanism 355 can generate a first token, and the generation mechanism 355 can apply the generated token as an input during a second pass. The process can repeat in a loop, successively generating and adding tokens (e.g., words) to the output from the preceding pass and applying the token embeddings of the composite sequence with positional encodings as an input to the decoder(s) 345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 335, except that it creates its queries from the layer below it and takes the keys and values (e.g., matrix) from the output of the encoder(s) 335.

As such, the decoder(s) 345 can output some decoded (e.g., vector) representation of the input being applied during a particular pass. The classifier 350 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 355 can select or sample a word or token based on a corresponding predicted probability (e.g., select the word with the highest predicted probability) and append it to the output from a previous pass, generating each word or token sequentially. The generation mechanism 355 can repeat the process, triggering successive decoder inputs and corresponding predictions until selecting or sampling a symbol or token that represents the end of the response, at which point, the generation mechanism 355 can output the generated response.

FIG. 3C is a block diagram of an example implementation in which the generative LM 330 includes a decoder-only transformer architecture. For example, the decoder(s) 360 of FIG. 3C can operate similarly as the decoder(s) 345 of FIG. 3B except each of the decoder(s) 360 of FIG. 3C omits the encoder-decoder self-attention layer (since there is no encoder in this implementation). As such, the decoder(s) 360 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 360. As with the decoder(s) 345 of FIG. 3B, each token (e.g., word) can flow through a separate path in the decoder(s) 360, and the decoder(s) 360, a classifier 365, and a generation mechanism 370 can use auto-regression to sequentially generate one token at a time until predicting a symbol or token that represents the end of the response. The classifier 365 and the generation mechanism 370 can operate similarly as the classifier 350 and the generation mechanism 355 of FIG. 3B, with the generation mechanism 370 selecting or sampling each successive output token based on a corresponding predicted probability and appending it to the output from a previous pass, generating each token sequentially until selecting or sampling a symbol or token that represents the end of the response. Generally, the generative LM 330 can perform tasks such as refining inferences for selected portions of image frames in a computer vision pipeline. That is, it can directly generate outputs, such as e.g., confidence scores or refined classifications for re-inference processes. These and other architectures described herein are meant simply as examples, and other architectures can be implemented within the scope of the present disclosure.

### Example Computing Device

FIG. 4 is a block diagram of an example computing device(s) 400 for use in implementing some implementations of the present disclosure. Generally, the example computing device(s) 400 can execute components of a computer vision pipeline, such as the primary detector 112, object tracker 116, selector 120, and/or secondary detector 124, to perform dynamic re-inference operations based on quality metrics. That is, the computing device(s) 400 can process data streams from sensors, apply generative language models to generate and/or analyze quality metrics, and/or select portions of image frames for further analysis or re-inference. For example, the computing device(s) 400 can utilize GPUs or processors to run models that determine when and how to re-infer specific portions of frames to improve detection accuracy and computational efficiency. Computing device 400 can include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one implementation, the computing device(s) 400 can include one or more virtual machines (VMs), and/or any of the components thereof can include virtual components (e.g., virtual hardware components). For non-limiting examples, one or more of the GPUs 408 can include one or more vGPUs, one or more of the CPUs 406 can include one or more vCPUs, and/or one or more of the logic units 420 can include one or more virtual logic units. As such, a computing device(s) 400 can include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some implementations, a presentation component 418, such as a display device, can be considered an I/O component 414 (e.g., if the display is a touch screen). As another example, the CPUs 406 and/or GPUs 408 can include memory (e.g., the memory 404 can be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 can represent one or more links or busses, such as an address bus, a data bus, a control bus, or a combination thereof. The interconnect system 402 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 406 can be directly connected to the memory 404. Further, the CPU 406 can be directly connected to the GPU 408. Where there is direct, or point-to-point connection between components, the interconnect system 402 can include a PCIe link to carry out the connection. In these examples, a PCI bus need not be included in the computing device 400.

The memory 404 can include any of a variety of computer-readable media. The computer-readable media can be any available media that can be accessed by the computing device 400. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 404 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 406 can be configured to execute at least some of the computer-readable instructions to control one or more components of the computing device 400 to perform one or more of the methods and/or processes described herein. The CPU(s) 406 can each include one or more cores (e.g., one, two, four, eight, twenty-eight, seventy-two, etc.) that are capable of handling a multitude of software threads simultaneously. The CPU(s) 406 can include any type of processor, and can include different types of processors depending on the type of computing device 400 implemented (e.g., processors with fewer cores for mobile devices and processors with more cores for servers). For example, depending on the type of computing device 400, the processor can be an Advanced RISC Machines (ARM) processor implemented using Reduced Instruction Set Computing (RISC) or an x86 processor implemented using Complex Instruction Set Computing (CISC). The computing device 400 can include one or more CPUs 406 in addition to one or more microprocessors or supplementary co-processors, such as math co-processors.

In addition to or alternatively from the CPU(s) 406, the GPU(s) 408 can be configured to execute at least some of the computer-readable instructions to control one or more components of the computing device 400 to perform one or more of the methods and/or processes described herein. One or more of the GPU(s) 408 can be an integrated GPU (e.g., with one or more of the CPU(s) 406 and/or one or more of the GPU(s) 408 can be a discrete GPU. In implementations, one or more of the GPU(s) 408 can be a coprocessor of one or more of the CPU(s) 406. The GPU(s) 408 can be used by the computing device 400 to render graphics (e.g., 3D graphics) or perform general purpose computations. For example, the GPU(s) 408 can be used for General-Purpose computing on GPUs (GPGPU). The GPU(s) 408 can include hundreds or thousands of cores that are capable of handling hundreds or thousands of software threads simultaneously. The GPU(s) 408 can generate pixel data for output images in response to rendering commands (e.g., rendering commands from the CPU(s) 406 received via a host interface). The GPU(s) 408 can include graphics memory, such as display memory, for storing pixel data or any other data, such as GPGPU data. The display memory can be included as part of the memory 404. The GPU(s) 408 can include two or more GPUs operating in parallel (e.g., via a link). The link can directly connect the GPUs (e.g., using NVLINK) or can connect the GPUs through a switch (e.g., using NVSwitch). When combined together, each GPU 408 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 406 and/or the GPU(s) 408, the logic unit(s) 420 can be configured to execute at least some of the computer-readable instructions to control one or more components of the computing device 400 to perform one or more of the methods and/or processes described herein. In implementations, the CPU(s) 406, the GPU(s) 408, and/or the logic unit(s) 420 can discretely or jointly perform any combination of the methods, processes and/or portions thereof. One or more of the logic units 420 can be part of and/or integrated in one or more of the CPU(s) 406 and/or the GPU(s) 408 and/or one or more of the logic units 420 can be discrete components or otherwise external to the CPU(s) 406 and/or the GPU(s) 408. In implementations, one or more of the logic units 420 can be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 can include one or more receivers, transmitters, and/or transceivers that allow the computing device 400 to communicate with other computing devices via an electronic communication network, included wired and/or wireless communications. The communication interface 410 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 420 and/or communication interface 410 can include one or more data processing units (DPUs) to transmit data received over a network and/or through interconnect system 402 directly to (e.g., a memory of) one or more GPU(s) 408.

The I/O ports 412 can allow the computing device 400 to be logically coupled to other devices including the I/O components 414, the presentation component(s) 418, and/or other components, some of which can be built in to (e.g., integrated in) the computing device 400. Illustrative I/O components 414 include a microphone, mouse, keyboard, joystick, game pad, game controller, satellite dish, scanner, printer, wireless device, etc. The I/O components 414 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 can be include depth cameras, such as stereoscopic camera systems, infrared camera systems, RGB camera systems, touchscreen technology, and combinations of these, for gesture detection and recognition. Additionally, the computing device 400 can include accelerometers or gyroscopes (e.g., as part of an inertia measurement unit (IMU)) that allow detection of motion. In some examples, the output of the accelerometers or gyroscopes can be used by the computing device 400 to render immersive augmented reality or virtual reality.

The power supply 416 can include a hard-wired power supply, a battery power supply, or a combination thereof. The power supply 416 can provide power to the computing device 400 to allow the components of the computing device 400 to operate.

The presentation component(s) 418 can include a display (e.g., a monitor, a touch screen, a television screen, a heads-up-display (HUD), other display types, or a combination thereof), speakers, and/or other presentation components. The presentation component(s) 418 can receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that can be used in at least one implementations of the present disclosure. The data center 500 can include a data center infrastructure layer 510, a framework layer 520, a software layer 530, and/or an application layer 540. Generally, the example data center 500 can support the execution of large-scale computer vision pipelines for dynamic re-inference based on quality metrics. That is, the data center 500 can provide the computational resources, such as CPUs, GPUs, and storage systems, to process data streams, run generative language models, and manage the selection and re-inference of image frame portions. For example, the data center 500 can host cloud-based services that allow for distributed processing of image frames, dynamic adjustment of inference parameters, and/or storage of refined inference outputs for further use in applications like autonomous vehicles or real-time surveillance systems.

As shown in FIG. 5, the data center infrastructure layer 510 can include a resource orchestrator 512, grouped computing resources 514, and node computing resources (“node C.R.s”) 516(1)-516(N), where “N” represents any whole, positive integer. In at least one implementation, node C.R.s 516(1)-516(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 516(1)-516(N) can correspond to a server having one or more of the above-mentioned computing resources. In addition, in some implementations, the node C.R.s 516(1)-5161(N) can include one or more virtual components, such as vGPUs, vCPUs, and/or the like, and/or one or more of the node C.R.s 516(1)-516(N) can correspond to a virtual machine (VM).

In at least one implementation, grouped computing resources 514 can include separate groupings of node C.R.s 516 housed within one or more racks (not shown), or many racks housed in data centers at various geographical locations (also not shown). Separate groupings of node C.R.s 516 within grouped computing resources 514 can include grouped compute, network, memory or storage resources that can be configured or allocated to support one or more workloads. In at least one implementation, several node C.R.s 516 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 512 can configure or otherwise control one or more node C.R.s 516(1)-516(N) and/or grouped computing resources 514. In at least one implementation, resource orchestrator 512 can include a software design infrastructure (SDI) management entity for the data center 500. The resource orchestrator 512 can include hardware, software, or some combination thereof.

In at least one implementation, as shown in FIG. 5, framework layer 520 can include a job scheduler 528, a configuration manager 534, a resource manager 536, and/or a distributed file system 538. The framework layer 520 can include a framework to support software 532 of software layer 530 and/or one or more application(s) 542 of application layer 540. The software 532 or application(s) 542 can respectively include web-based service software or applications, such as those provided by Amazon Web Services, Google Cloud and Microsoft Azure. The framework layer 520 can be, but is not limited to, a type of free and open-source software web application framework such as Apache Spark™ (hereinafter “Spark”) that can use distributed file system 538 for large-scale data processing (e.g., “big data”). In at least one implementation, job scheduler 528 can include a Spark driver to facilitate scheduling of workloads supported by various layers of data center 500. The configuration manager 534 can be capable of configuring different layers such as software layer 530 and framework layer 520 including Spark and distributed file system 538 for supporting large-scale data processing. The resource manager 536 can be capable of managing clustered or grouped computing resources mapped to or allocated for support of distributed file system 538 and job scheduler 528. In at least one implementation, clustered or grouped computing resources can include grouped computing resource 514 at data center infrastructure layer 510. The resource manager 536 can coordinate with resource orchestrator 512 to manage these mapped or allocated computing resources.

In at least one implementation, software 532 included in software layer 530 can include software used by at least portions of node C.R.s 516(1)-516(N), grouped computing resources 514, and/or distributed file system 538 of framework layer 520. One or more types of software can include, but are not limited to, Internet web page search software, e-mail virus scan software, database software, and streaming video content software.

In at least one implementation, application(s) 542 included in application layer 540 can include one or more types of applications used by at least portions of node C.R.s 516(1)-516(N), grouped computing resources 514, and/or distributed file system 538 of framework layer 520. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 534, resource manager 536, and resource orchestrator 512 can implement any number and type of self-modifying actions based on any amount and type of data acquired in any technically feasible fashion. Self-modifying actions can relieve a data center operator of data center 500 from making possibly bad configuration decisions and possibly avoiding underutilized and/or poor performing portions of a data center.

The data center 500 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 500. In at least one implementation, trained or deployed machine learning models corresponding to one or more neural networks can be used to infer or predict information using resources described above with respect to the data center 500 by using weight parameters calculated through one or more training techniques, such as but not limited to those described herein.

In at least one implementation, the data center 500 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 400 of FIG. 4—e.g., each device can include similar components, features, and/or functionality of the computing device(s) 400. In addition, where backend devices (e.g., servers, NAS, etc.) are implemented, the backend devices can be included as part of a data center 500, an example of which is described in more detail herein with respect to FIG. 5.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 400 described herein with respect to FIG. 4. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
processing circuitry to:
determine at least one quality metric associated with performing at least one operation on an image frame, the at least one operation corresponding to an image processing pipeline associated with performing a first inference operation and a second inference operation on the image frame;
select a portion of the image frame to perform the second inference operation responsive to the at least one quality metric satisfying a re-inference condition; and
perform, using at least one machine learning model, the second inference operation for the portion of the image frame.

2. The one or more processors of claim 1, wherein the re-inference condition is satisfied based at least on the at least one quality metric exceeding a previous quality metric or exceeding a predefined quality metric threshold.

3. The one or more processors of claim 1, wherein the at least one quality metric comprises at least one of (i) a first confidence metric, (ii) a tracking confidence metric, (iii) a second confidence metric, or (iv) a decoder metric.

4. The one or more processors of claim 3, wherein performing the at least one operation comprises performing, using the at least one machine learning model, the first inference operation on the image frame to determine the first confidence metric, the first confidence metric corresponding to a first accuracy of a detection of an object of the image frame.

5. The one or more processors of claim 4, wherein performing the at least one operation comprises generating, using an object tracker, tracking data regarding the object tracked by the object tracker between a first image frame and a second image frame to determine the tracking confidence metric, the tracking confidence metric corresponding to a consistency of the object of the image frame tracked over at least the first image frame and the second image frame.

6. The one or more processors of claim 4, wherein performing the at least one operation comprises performing, using the at least one machine learning model, the second inference operation on the portion of the image frame to determine the second confidence metric, the second confidence metric corresponding to a second accuracy of the detection of the object of the image frame.

7. The one or more processors of claim 3, wherein performing the at least one operation comprises decoding, using a decoder, a plurality of input frames to obtain the image frame and determine the decoder metric, the decoder metric corresponding to one or more errors or bit allocations of the plurality of input frames.

8. The one or more processors of claim 3, wherein the processing circuitry is to:
select a second portion of the portion of the image frame to perform a third inference operation responsive to the at least one quality metric satisfying a second re-inference condition; and
perform, using the at least one machine learning model, the third inference operation for the second portion of the portion of the image frame.

9. The one or more processors of claim 1, wherein the one or more processors are comprised in at least one of:
a system for performing simulation operations;
a system for performing collaborative content creation for 3D assets;
a system for generating synthetic data;
a system comprising one or more vision language models (VLMs);
a system comprising one or more large language models (LLMs);
a system comprising one or more small language models (SLMs);
a system for performing conversational AI operations;
a system for performing light transport simulation;
a system for performing deep learning operations;
a system for performing digital twin operations;
a control system for an autonomous or semi-autonomous machine;
a perception system for an autonomous or semi-autonomous machine;
a system incorporating one or more virtual machines (VMs);
a system implemented using a robot;
a system implemented using an edge device;
a system implemented at least partially in a data center; or
a system implemented at least partially using cloud computing resources.

10. A system, comprising:
one or more processors to execute operations comprising:
determine that at least one quality metric, associated with performing at least one operation on an image frame, satisfies a re-inference condition, the at least one operation corresponding to an image processing pipeline associated with performing a plurality of inference operations on the image frame;
in response to the determination, perform, using at least one machine learning model, at least one subsequent inference operation of the plurality of inference operations on at least a portion of the image frame identified during at least one previous inference operation of the plurality of inference operations; and
transform at least output data from the plurality of inference operations in a format for at least one of storage or transmission.

11. The system of claim 10, wherein the re-inference condition is satisfied based at least on the at least one quality metric exceeding a previous quality metric or exceeding a predefined quality metric threshold.

12. The system of claim 10, wherein the at least one quality metric comprises at least one of (i) a first confidence metric, (ii) a tracking confidence metric, (iii) a second confidence metric, or (iv) a decoder metric.

13. The system of claim 12, wherein performing the at least one operation comprises performing, using the at least one machine learning model, the at least one previous inference operation on the image frame to determine the first confidence metric, the first confidence metric corresponding to a first accuracy of a detection of an object of the image frame.

14. The system of claim 13, wherein performing the at least one operation comprises generating, using an object tracker, tracking data regarding the object tracked by the object tracker between a first image frame and a second image frame to determine the tracking confidence metric, the tracking confidence metric corresponding to a consistency of the object of the image frame tracked over at least the first image frame and the second image frame.

15. The system of claim 13, wherein performing the at least one operation comprises performing, using the at least one machine learning model, the at least one subsequent inference operation on at least the portion of the image frame to determine the second confidence metric, the second confidence metric corresponding to a second accuracy of the detection of the object of the image frame.

16. The system of claim 12, wherein performing the at least one operation comprises decoding, using a decoder, a plurality of input frames to obtain the image frame and determine the decoder metric, the decoder metric corresponding to one or more errors or bit allocations of the plurality of input frames.

17. The system of claim 12, wherein the one or more processors to execute the operations further comprising:
select a second portion of the portion of the image frame to perform the one or more subsequent inference operation responsive to the at least one quality metric satisfying a second re-inference condition; and
perform, using the at least one machine learning model, the one or more subsequent inference operation for the second portion of the portion of the image frame.

18. A method, comprising:
determining at least one quality metric associated with performing at least one operation on an image frame, the at least one operation corresponding to an image processing pipeline associated with performing, using at least one machine learning model, a first inference operation and a second inference operation on the image frame;
in response to the at least one quality metric satisfying a re-inference condition, performing the second inference operation on a portion of the image frame identified from the first inference operation; and
generating a data stream based at least on output data from at least the first inference operation and the second inference operations.

19. The method of claim 18, wherein the re-inference condition is satisfied based on the least one quality metric exceeding a previous quality metric or exceeding a predefined quality metric threshold.

20. The method of claim 18, wherein the at least one quality metric comprises at least one of (i) a first confidence metric, (ii) a tracking confidence metric, (iii) a second confidence metric, or (iv) a decoder metric.
